(19) United States
(12) Patent Application Publication
(10) Pub. No.: US 2023/0082347 A1
(43) Pub. Date: Mar. 16, 2023

(54) RADIATION CURABLE TWO-COMPONENT AQUEOUS COATING COMPOSITION, AND COATED ARTICLE MADE THEREFROM

(71) Applicant: GUANGDONG HUARUN PAINTS CO., LTD, Foshan City (CN)

(72) Inventors: Jianguang PU, Shanghai (CN); Yanfei HAO, Shanghai (CN); Yu ZHOU, Shanghai (CN)

(21) Appl. No.: 17/806,512

(22) Filed: Jun. 13, 2022

(30) Foreign Application Priority Data
Jul. 9, 2021 (CN) 202110780318.6

(51) Int. Cl. C09D 175/14

(52) U.S. Cl. CPC C09D 175/14

(57) ABSTRACT

The present application relates to a radiation curable two-component aqueous coating composition and coated article made therefrom. The radiation-curable two-component aqueous coating composition comprises Component A, comprising at least one radiation-curable hydroxy-functional polymer, at least one photoinitiator and at least one organic matting agent; and Component B, comprising at least one polyisocyanate; wherein the organic matting agent is an acrylics polymer in the form of a dry powder, and the dry powder has a particle size of in the range of 4-8 microns, as measured by laser diffraction particle size analyzer using ISO 13320 (2009) (the Malvern method); and wherein when the radiation curable two-component aqueous coating composition is cured to form a coating, the coating has a gloss of no higher than 50 at 60° using ASTM D523.

### TECHNICAL FIELD

The present application relates to a radiation curable two-component aqueous coating composition and coated article made therefrom.

### BACKGROUND

At present, with the increasing awareness of environmental protection and the increasing control of solvent-based paints by various governments, paints, especially wood paints, are undergoing a comprehensive transformation from solvent-borne products to aqueous products. However, the aqueous wood paints have a higher single-coat construction thickness, usually in the range of 100-130 g/m², which thickness is much higher than that of the conventional metal-plastic paint in the range of 30-60 g/m². Therefore, the durability and physical and chemical properties of aqueous wood coatings have been widely questioned.

As an aqueous wood paint with a better performance, a radiation-curable aqueous coating composition has improved durability. Nevertheless, for products such as cabinets and door panels with higher requirements, the radiation-curable aqueous coating composition is difficult to reach the requirements of the existing solvent-borne wood paint due to its chemical resistance and hardness, and has the problems of incomplete drying on special-shaped parts. Thus, the promotion of radiation-curable aqueous coating compositions has being limited.

In addition, low-gloss coatings have more elegant and softer visual effects compared with high-gloss coatings, and are especially suitable for advanced wood products. With people's pursuit of high-quality life, the demand for low-gloss aqueous coatings is increasing. Low gloss coatings are mainly achieved by adding a certain amount of matting agent to a coating composition at the current coating industry. After forming a paint film from the coating composition thus obtained, the matting agent particles dispersed in the paint film make the surface uneven, increase scattering of light and reduce reflection of light, thereby producing a low gloss effect. However, due to its characteristics of the matting agent itself, common matting agents such as micron-sized silica are difficult to disperse in a polymer emulsion, are prone to sedimentation upon long-term storage and produce poor chemical resistance. In addition, matting agents have a poor transparency and accordingly are easy to cause whitening phenomenon and of reduce transparency of the resulting paint film. At the same time, the matting agent has a strong thickening property, and its addition amount is limited, so it is difficult to obtain products with lower gloss.

Accordingly, there is a need in the coatings industry for improved radiation-curable aqueous coating compositions that provide low gloss effects.

### SUMMARY

The present application in a first aspect provides a radiation-curable two-component aqueous coating composition comprising: Component A, comprising at least one radiation-curable hydroxy-functional polymer, at least one photoinitiator and at least one organic matting agent; and Component B, comprising at least one polyisocyanate; wherein the organic matting agent is an acrylics polymer in the form of a dry powder, and the dry powder has a particle size of in the range of 4-8 microns, as measured by laser diffraction particle size analyzer using ISO 13320 (2009) (the Malvern method); and wherein when the radiation curable two-component aqueous coating composition is cured to form a coating, the coating has a gloss of no higher than 50 at 60° using ASTM D523. Preferably, the dry powder has a particle size of in the range of 5 to 7 microns.

In a preferred embodiment of the present application, the Component A of the radiation-curable two-component aqueous coating composition comprises a caprolactone-based hydroxy-functional polyurethane (meth)acrylate as the radiation-curable hydroxy-functional polymer, and comprises a combination of acylphosphine oxides and α-hydroxy ketones as the photoinitiator.

The present application in a second aspect provides a coated product comprising a substrate, comprising at least one major surface; and a coating applied on part or all of the main surface of the substrate that is formed from the radiation-curable two-component aqueous coating composition as described in the first aspect of the present application. In some embodiments of the present application, the substrate comprises one or more of wood, glass, ceramic, metal, plastic, and cement board, preferably the substrate comprises wood.

In the present application, it was proposed to add an organic matting agent with a specific particle size to a dual-curing system composed of a radiation-curable hydroxyl-functional polymer, a polyisocyanate and a photoinitiator. It was surprising that the combination produces a synergistic effect. The above-mentioned polyacrylic organic matting agent with a specific particle size can not only produce a good matting effect, but also can just fill voids remaining due to volatilization of moisture and solvent during the film-forming process, so as to improve the adhesion of the coating. The resulting coatings showed significantly improved chemical resistance using ASTM F2250-Test Method B, which was unexpected.

It was surprisingly found that, in the radiation-curable two-component aqueous coating composition according to the present application, when the Component A comprises a caprolactone-based hydroxy-functional polyurethane (meth)acrylate as the radiation-curable hydroxy-functional polymer, and comprises a combination of acylphosphine oxides and α-hydroxy ketones as the photoinitiator, the aqueous coating compositions formulated therefrom exhibit particularly excellent color stability after curing, which was unexpected prior to the present application.

Moreover, the radiation-curable two-component aqueous coating compositions according to the present application have broad applicability and can be based on various resin systems. For example, the radiation-curable two-component aqueous coating composition according to the present application can be formulated based on various resin systems such as epoxy, polyurethane, polyester, polyether, polyacrylate, and the like.

The details of one or more embodiments of the present application are set forth in the description below. Other features, objects, and advantages of the present application will be apparent from the description, and from the claims.

### DETAILED DESCRIPTION

As used herein, “a”, “an”, “the”, “at least one”, and “one or more” are used interchangeably. Thus, for example, a coating composition that comprises “an” additive can be interpreted to mean that the coating composition includes “one or more” additives. The use of the singular form herein is intended to include the plural form unless otherwise indicated herein.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in the present application, as along as such components or steps do not affect the basic and novel characteristics of the present application, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

As used herein, “coating” has the same meaning as “paint film”, both of which are formed by applying and drying an aqueous coating composition.

When used in reference to “an organic matting agent”, the phrase “the organic matting agent is in the form of a dry powder” means that the organic matting agent is in the form of free-flowable powder particles that are substantially free of water.

When used in reference to “an organic matting agent”, the term “particle size” refers to a parameter used to measure powder particle size of an organic matting agent in the form of a dry powder. For substantially spherical powder particles, the particle size is substantially equal to average diameter of the particles. For non-spherical powder particles, such as irregular, elongated, needle-like, fibrous, or rod-like forms, the particle size refers to the distance between the farthest ends along outer periphery of particles. In many embodiments of the present application, the particle size of the organic matting agent can be determined by a laser diffraction particle size analyzer using ISO 13320 (2009) (the Malvern method). Specifically, the laser diffraction particle size technique may use a Malvern Zetasizer. The Malvern method uses a laser diffraction particle size analyzer, the Malvern Zetasizer, that can measure the particle size and the particle size distribution of materials at a 90-degree scattering angle. In particular, the Malvern method uses Mie theory of light scattering.

When used in reference to “an aqueous coating composition”, the expression “the coating formed from the aqueous coating composition has a gloss of no higher than 50 at 60°” using ASTM D523 means that the coating formed from the aqueous coating composition have lower gloss.

As used herein, the term “aqueous colorless varnish” refers to a clear waterborne paint that is substantially free of any colorants, and the paint film or coating formed therefrom is generally transparent or translucent. In one embodiment according to the present application, the radiation-curable two-component aqueous coating composition is an aqueous colorless varnish. In the case where the radiation-curable two-component aqueous coating composition is an aqueous colorless varnish, radiation curing can be achieved using common photoinitiators known in the art, including but not limited to an acylphosphine oxide, an alpha-hydroxyketone, an alpha-aminoketone, a benzophenone, or other photoinitiators commonly used in radiation curable coating compositions.

As used herein, the term “aqueous solid color topcoat” refers to a pigmented, colorant-containing waterborne paint with hiding power from which the paint film or coating is opaque. In one embodiment according to the present application, the radiation-curable two-component aqueous coating composition is an aqueous solid color topcoat. In the case where the radiation-curable two-component aqueous coating composition is an aqueous solid color topcoat, a combination of an acylphosphine oxide with a hydroxyketone is preferably used as photoinitiators.

In the context of the present application, the term “two-component aqueous coating composition” refers to an aqueous coating composition consisting of two or more separately stored components, the components of which are mixed upon application together, and can be dried and cured within an acceptable period of time to form a coating with desired mechanical properties such as hardness.

The terms “preferred” and “preferably” refer to embodiments of the present application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present application.

### DETAILED DESCRIPTION

According to the present embodiments of the present application, a radiation-curable two-component aqueous coating composition is provided, which composition comprises: Component A, comprising at least one radiation-curable hydroxy-functional polymer, at least one photoinitiator and at least one organic matting agent; and Component B, comprising at least one polyisocyanate; wherein the organic matting agent is an acrylics polymer in the form of a dry powder, and the dry powder has a particle size of in the range of 4-8 microns, as measured by laser diffraction particle size analyzer using ISO 13320 (2009) (the Malvern method); and wherein when the radiation curable two-component aqueous coating composition is cured to form a coating, the coating has a gloss of no higher than 50 at 60° using ASTM D523.

As mentioned above, the radiation-curable two-component aqueous coating composition according to the present application is a dual-cure system, the Component A of which comprises at least one radiation-curable hydroxy-functional polymer and at least one photoinitiator, and the Component B of which comprises at least one polyisocyanate. It was found that the application effect is particularly excellent when the dual-cure system according to the present application is used to coat wood articles with profiled structures such as sides, chamfers, grooves, and the like. Without being bound by any theory, it is speculated that in the application of wood articles with profiled structures, the radiation-curable hydroxy-functional polymer is rapidly cured by UV irradiation under the action of photoinitiators; meanwhile, in areas that are not irradiated or irradiated insufficiently, the radiation-curable hydroxy-functional polymer can continue to undergo condensation reactions with polyisocyanate as a curing agent to further increase crosslink density of the coating, thus the resulting coating thus formed has excellent curing performance.

In an embodiment according to the present application, Component A of the radiation-curable two-component aqueous coating composition comprises an acrylics organic matting agent having a specific particle size. It was surprisingly found that by incorporating an acrylics organic matting agent with a specific particle size into a dual-cure system consisting of a radiation curable hydroxyl functional polymer, a polyisocyanate and a photoinitiator, the aqueous coating compositions formed therefrom can not only show a better matting effect, but also have a significantly higher chemical resistance, which was difficult to foresee prior to the present application. Without being bound by any theory, it is speculated that the acrylics organic matting agent with a specific particle size is different from the conventional inorganic matting agent in nature, and it can be compatible with the resin components of the paint film well and can just fill voids left in the paint film with the volatilization of moisture and solvent due to its particle size during the film formation process, so the resulting paint film has a coherent surface in addition to low gloss, showing good chemical resistance using ASTM F2250-Test Method B.

In an embodiment according to the present application, the organic matting agent is an acrylics polymer in the form of a dry powder, and the dry powder has a particle size in the range of 4-8 microns. As mentioned above, the term “particle size” refers to a parameter used to measure powder particle size of an organic matting agent in the form of a dry powder, as determined using laser diffraction particle size analyzer using ISO 13320 (2009) (the Malvern method). It was found that the particle size of the organic matting agent can substantially affect the chemical resistance of the coating (according to ASTM F2250-Test Method B) formed from the aqueous coating composition. If the particle size of the organic matting agent is too large, it cannot well fill voids left in the coating with the volatilization of moisture and solvents, and the improvement of the chemical resistance of the resulting coating is limited; if the particle size of the organic matting agent is too small, it likewise cannot effectively fill the voids, and the improvement of the chemical resistance of the coating is also insufficient. Therefore, in an embodiment of the present application, acrylic organic matting agents with a particle size in the range of 4-8 microns are preferred. More preferably, the acrylic organic matting agent has particle size in the range of 5-7 microns.

As described above, the coating formed from the aqueous coating composition according to the present application has a gloss of no higher than 50 at 60° using ASTM D523 and exhibits a low gloss effect. Preferably, the paint film formed from the aqueous coating composition of the present application has a gloss of no higher than 45 at 60° using ASTM D523, preferably a gloss of no higher than 40 at 60°, more preferably a gloss of no higher than 35 at 60°, still more preferably a gloss of no higher than 30 at 60°, even more preferably a gloss of no higher than 25 at 60°, even more preferably a gloss of no higher than 10 at 60°. Compared with coatings formed from aqueous coating compositions formulated with conventional matting agents on the market, including inorganic silica matting agents and surface-modified inorganic silica matting agents, the resulting coating formed from the aqueous coating compositions according to the present application has comparable or lower gloss.

In some embodiments according to the present application, the coating formed from the aqueous coating composition according to the present application has, in addition to the above gloss, a chemical resistance using ASTM F2250-Test Method B of grade 4 or higher, wherein the chemical resistance is determined according to the Examples section of the present application. Preferably, the paint film formed from the aqueous coating composition of the present application has a resistance to at least one or more or all of acids, bases, alcohols, coffee, and water of grade 4 or higher, preferably, of grade 5 or higher. In contrast, conventional waterborne topcoats with low gloss on the market do not have low gloss and high chemical resistance both.

In some embodiments according to the present application, the polyacrylics organic matting agent may be those polymers having an acrylics backbone obtained by polymerization of acrylics unsaturated monomers. Such a polyacrylic organic matting agent can be synthesized using conventional polymerization methods known to those of ordinary skill in the art, or can be commercially available, such as PMMA ultrafine powder.

In some embodiments according to the present application, the organic matting agent is present in an amount of 2-8% by weight, preferably in an amount of 3-7% by weight, more preferably in an amount of 3-6% by weight, even more preferably in an amount of 3.5-5.5% by weight relative to the total weight of the Component A. The amount of the organic matting agent is appropriate within the above range. In some embodiments of the present application, relative to the total weight of the Component A, the organic matting agent is present in an amount of 3.5-7% by weight, 3.5-6% by weight, 3.5-5.5% by weight, 3.5-5% by weight, 3.5-4.5% by weight, 3.5-4% by weight, 4-7% by weight, 4-6% by weight, 4-5.5% by weight, 4-5% by weight, 4.5-7% by weight, 4.5-6% by weight, 4.5-5.5% by weight, 4.5-5% by weight, 5-7% by weight, 5-6% by weight, or in an amount within the range of any value within the above range.

In an embodiment according to the present application, the Component A is a composition that constitutes the bulk of the coating formed from the aqueous coating composition, which can be dried, cross-linked or otherwise hardened by itself or with a suitable curing agent as required, thereby forming a non-tacky continuous film on the substrate. In addition to the organic matting powders described above, the Component A further comprises at least one radiation-curable hydroxy-functional polymer and at least one photoinitiator.

In an embodiment according to the present application, the radiation-curable hydroxy-functional polymer contained in the Component A as a resin component is radiation-curable, preferably UV-curable. In other words, in some embodiments according to the present application, the radiation-curable hydroxy-functional polymer has ethylenically unsaturated functional groups that can undergo free radical polymerization under the influence of radiation and/or (photo)initiators, and thus it is radiation curable, wherein the radiation refers to exposure to actinic radiation, such as ultraviolet radiation, gamma-rays, or X-rays, or exposure to electron beams. Radiation-curable ethylenically unsaturated functional groups typically include carbon-carbon double bonds, preferably derived from (meth)acrylics, particularly preferably from (meth)acrylates.

In an embodiment according to the present application, the radiation-curable hydroxy-functional polymer contained in the Component A has a hydroxy-functional group in addition to ethylenically unsaturated functional groups. In one embodiment according to the present application, the radiation curable hydroxyl functional polymer has a hydroxyl value of no higher than 150 mg KOH/g using ISO 4629, preferably in the range of 40-150 mg KOH/g, more preferably in the range of 60-120 mg KOH/g, even more preferably in the range of 80-100 mg KOH/g, so as to achieve the desired curing effect. The hydroxyl number is measured by titration according to ISO 4629. If the hydroxyl value of the polymer is too high, the Component A as formulated will gel quickly upon mixing with the curing agent, which is not suitable for construction operations; if the hydroxyl value of the polymer is too low, the Component A as formulated will react with the curing agent slowly, resulting in a decrease in construction efficiency. Accordingly, in some embodiments according to the present application, the hydroxyl value of the radiation-curable hydroxyl-functional polymer within the above-mentioned range is appropriate, such that the mixture by the Component A as formulated with a curing agent has an appropriate pot life.

In some embodiments according to the present application, the radiation-curable hydroxy-functional polymer is a hydroxy-functional polymer with ethylenically unsaturated functional groups, including hydroxy-functional epoxy (meth)acrylates, hydroxy-functional polyurethane (meth)acrylates, hydroxyl functional polyester (meth)acrylates, hydroxyl functional polyether (meth)acrylates, hydroxyl functional polyacrylate (meth)acrylates or combinations thereof, preferably hydroxy functional urethane (meth)acrylates.

In some preferred embodiments according to the present application, the radiation-curable hydroxy-functional polymer comprises a modified hydroxy-functional polyurethane (meth)acrylate, preferably a caprolactone-based hydroxy-functional polyurethane (meth)acrylate.

In some embodiments according to the present application, the radiation-curable hydroxy-functional polymer is in the form of an aqueous dispersion of polymer particles. As used herein, the term “aqueous dispersion of polymer particles” refers to a stable dispersion of synthetic resin (i.e. polymer) in the form of microparticles in an aqueous liquid medium, optionally with the aid of a suitable dispersing aids such as surfactant. Therefore, when used for polymers in the present application, unless otherwise stated, the terms “aqueous latex” and “aqueous dispersion” can be used interchangeably. The process for preparing an aqueous latex is known in the art, for example, it can be prepared by the emulsion polymerization process known to those skilled in the art. The emulsion polymerization preparation process usually comprises the following steps: optionally under the action of a suitable emulsifier and/or dispersion stabilizer and with the aid of stirring, dispersing polymerizable monomers in water to form an emulsion, and polymerizing the monomers for example, by adding an initiator so as to initiate the polymerization.

In some embodiments according to the present application, an aqueous dispersion of polymer particles is regarded as a film-forming resin component in an aqueous coating composition. The resin component is used as an adhesive to provide adhesion between paint film and substrate, and to keep the components (such as fillers) in the aqueous coating composition together to give the paint film a certain degree of cohesive strength.

In some preferred embodiments of the present application, the aqueous dispersion of polymer particles includes an aqueous dispersion of a hydroxy-functional epoxy (meth)acrylate, an aqueous dispersion of a hydroxy-functional polyurethane (meth)acrylate, an aqueous dispersion of a hydroxy-functional polyester (meth)acrylate, an aqueous dispersion of a hydroxy-functional polyether (meth)acrylate, an aqueous dispersion of a hydroxy-functional polyacrylates (meth)acrylate or a combination thereof, preferably an aqueous dispersion of a hydroxyl functional polyurethane (meth)acrylate.

In an embodiment according to the present application, the polymer particles in the aqueous dispersion have a certain range of particle size, which can be measured by the Z average particle diameter known in the art, which means the particles size as measured by a dynamic light scattering method, for example, with a Marvlen Zetasizer 3000HS microscopic particle size analyzer using ASTM D8090-17 may be used. Preferably, the polymer particles of the aqueous dispersion may have a particle size in the range of 50 nm to 200 nm. It has been surprisingly discovered that an aqueous dispersion of polymer particles having the above-mentioned particle size range is particularly suitable for formulating an aqueous coating composition, and the aqueous coating composition formulated therefrom has suitable rheology and coat-ability.

In an embodiment of the present application, the aqueous dispersion of polymer particles has a solid content of 30-50%. From the perspective of industrial practice, an aqueous dispersion of polymer particles with the above solid content is readily available. The above-mentioned aqueous dispersion of polymer particles can be self-made or are commercially available products. As an exemplary illustration, commercially available radiation-curable polyurethane acrylate aqueous dispersions can be given.

According to an embodiment of the present application, the amount of the radiation-curable hydroxy-functional polymer can be varied within a wide range, and the amount of the radiation-curable hydroxy-functional polymer can be in the range of about 65 wt % to about 80 wt % relative to the total weight of the component A. In some embodiments, the amount of the radiation-curable hydroxy-functional polymer may be in the range of 75 wt % to 85 wt %.

In some embodiments according to the present application, the Component A of the radiation-curable two-component aqueous coating composition comprises a photoinitiator that is UV-curable. The coating composition is exposed to UV light to undergo a curing reaction. Photoinitiators suitable for the coating compositions of the present application include alpha-cleavage type photoinitiators, hydrogen abstraction type photoinitiators, or combinations thereof. The photoinitiator may contain other reagents that aid in the photochemical reaction, such as co-initiators or photoinitiator synergists. Suitable photoinitiators include acylphosphine oxides, alpha-hydroxy ketones, alpha-amino ketones, benzophenones, or combinations thereof.

In some embodiments according to the present application, the photoinitiator comprises alpha-amino ketones. In the context of the present application, the term “α-amino ketones” refers to a class of organic compounds that contain an amino group and a ketone group in the same molecule, with the amino group being in an α-position of the keto group. According to the present application, alpha-amino ketones include alpha-aminoalkyl phenyl ketones. Examples of α-aminoalkyl phenyl ketones suitable for use in the present application include, but are not limited to, 2-benzyl-2-(dimethylamino)-1-[4-(4-morpholinyl)phenyl]-1-butanone, 2-dimethylamino-2-(4-methylbenzyl)-1-(4-morpholin-4-yl-phenyl)-butan-1-one, or any combination thereof.

In some embodiments according to the present application, the photoinitiator comprises alpha-hydroxy ketones. In the context of the present application, the term “alpha-hydroxy ketones” refer to a class of organic compounds that contain a hydroxyl group and a ketone group in the same molecule, with the hydroxyl group being in an α-position of the keto group. Examples of alpha-hydroxy ketones suitable for use in the present application include, but are not limited to, 1-hydroxycyclohexyl phenyl ketone or 2-hydroxy-1-[4-(2-hydroxyethoxy)phenyl]-2-methyl-1-acetone; or any combination thereof.

In some embodiments according to the present application, the photoinitiator comprises acylphosphine oxides. According to the present application, the acylphosphine oxides include monoacylphosphine oxide, bisacylphosphine oxide or a combination thereof. As an illustration example, the bisacylphosphine oxides may be a compound of formula (I)

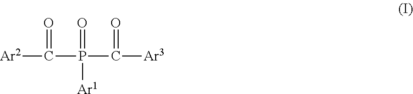

wherein Ar¹, Ar² and Ar³ are each independently substituted or unsubstituted C6-C18 aryl or C1-C6 alkyl. The monoacylphosphine oxides has a similar structure to bisacylphosphine oxides, except that only one acyl group is directly attached to phosphorus atom. As an illustration example, the monoacylphosphine oxide may be a compound of formula (II):

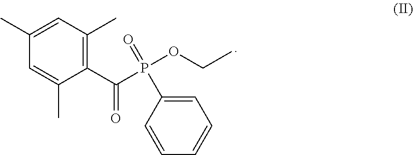 [SMILES: CCOP(=O)(C(=O)c1c(C)cc(C)cc1C)c1ccccc1]

Acylphosphine oxides suitable for use in the present application include, but are not limited to, 2,4,6-trimethylbenzoyldiphenylphosphine oxide, 2,4,6-trimethylbenzozylphenylphosphonate, bis(2,4,6-trimethylbenzoyl)-phenylphosphine oxide, or any combination thereof. In a preferred embodiment according to the present application, the initiator comprises bisacylphosphine oxides, such as bis(2,4,6-trimethylbenzoyl)-phenylphosphine oxide.

In some embodiments according to the present application, the photoinitiator includes benzophenones-based hydrogen abstraction type photoinitiators, including benzophenones; substituted benzophenones, or combinations thereof. As an illustration example, the benzophenones may be, for example, benzophenone, 2,4,6-trimethylbenzophenone, 4-methylbenzophenone, 2-methylbenzophenone, 2-methoxy carbonylbenzophenone, 4,4′-bis(chloromethyl)benzophenone, 4-chlorobenzophenone, 4-phenylbenzophenone, 4,4′-bis(dimethylamino)benzophenone, 4,4′-bis(diethylamino) benzophenone, methyl 2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone.

According to ab embodiment of the present application, the amount of the photoinitiator can be adjusted as required, and the amount thereof can be in the range of about 1% by weight to about 3% by weight relative to the total weight of the Component A. In some embodiments, the amount of photoinitiator may be in the range of 1% by weight to 2% by weight.

It was surprisingly found that, upon formulating the radiation-curable two-component aqueous coating compositions according to the present application, coating compositions that exhibit particularly excellent color stability may be obtained by specifically selecting a caprolactone-based modified hydroxy-functional polyurethane (methyl)acrylate as a radiation-curable hydroxy-functional polymer, and selecting a combination of acylphosphine oxides and alpha-hydroxy ketones as a photoinitiator, which is unexpected prior to the present application. Thus, in a preferred embodiment according to the present application, in the radiation-curable two-component aqueous coating composition according to the present application, Component A comprises a caprolactone-based hydroxy-functional polyurethane (meth)acrylate as a radiation curable hydroxyl functional polymer and a combination of an acylphosphine oxide and an alpha-hydroxy ketone as a photoinitiator.

In some embodiments according to the present application where a combination of acylphosphine oxides and alpha-hydroxy ketones is used as the photoinitiator, the weight ratio of acyl phosphine oxides and alpha-hydroxy ketones is in the range of 1:2 to 2:1, more preferably in the range of 1:1.5 to 1.5:1, for example, it may be 1:1.

In some embodiments according to the present application, the color stability of the radiation-curable two-component aqueous coating composition is characterized by a color difference value ΔE before and after irradiation upon subjecting to a QUV aging test using ASTM G154 for 360 hours after it is cured on a white substrate to form a coating. Generally, the smaller the above-mentioned color difference value ΔE, the better the color stability is. Therefore, after the radiation-curable two-component aqueous coating composition according to the present application is cured on a white substrate to form a coating, the coating has a color difference value before and after irradiation upon subjecting to a QUV aging test using ASTM G154 for 360 hours of ΔE<2.0, preferably <1.4, more preferably <1.35.

In the radiation curable two-component aqueous coating composition of the present application, the Component A may further include other conventional additives commonly used in aqueous coating compositions, and these additives will not adversely affect the radiation curable two-component aqueous coating composition or the cured coating obtained therefrom. Suitable additives include, for example, those that improve the processing or manufacturing properties of the composition, improve the specific functional properties or characteristics of the coating composition or the cured composition obtained therefrom, such as adhesion to the substrate or reduce the cost. Additional additives that may be included are, for example, carriers (e.g. water), colorants (including color slurry or toners), fillers, coalescents, lubricants, wetting agents, plasticizers, surfactants, defoamers, biocides, pigments, antioxidants, flow control agents, thixotropic agents, dispersants, adhesion promoters, UV stabilizers, pH adjusters, or combinations thereof. The content of each optional component is sufficient to achieve its intended purpose, but preferably, such content does not adversely affect the radiation-curable two-component aqueous coating composition or the cured coating obtained therefrom. In a preferred embodiment of the present application, the Component A of the radiation curable two-component aqueous coating composition may optionally contain colorants, water, coalescents, thickeners, surfactants, defoamers, biocides or any of these combination as a conventional additive. According to the present application, the total amount of conventional additives ranges from 0% by weight to about 48% by weight relative to the total weight of the Component A.

In a particular embodiment of the present application, the Component A of the radiation curable two-component aqueous coating composition comprises, relative to the total weight of the component A,

65 to 90% by weight of the radiation-curable hydroxyl functional polymer;
2 to 8% by weight of the organic matting agent;
1 to 3% by weight of the photoinitiator; and
0 to 30% by weight of additional additives, including, colorants, water, coalescents, thickeners, surfactants, defoamers, bactericides, or any combination thereof.

In an embodiment according to the present application, the radiation-curable two-component aqueous coating composition further comprises as component B a polyisocyanate. As used herein, the term, “polyisocyanate”, is intended to refer to a polyisocyanate compound, a polyisocyanate prepolymer, or a combination thereof. The polyisocyanate has two or more isocyanate functional groups, and is capable of reacting with the radiation curable hydroxyl functional polymer to achieve further curing, thereby increasing the cross-linking density of the resulting coating.

Suitable polyisocyanate includes aliphatic polyisocyanates, aromatic polyisocyanates, or any combination thereof. As used herein, the term, “aliphatic polyisocyanates”, is intended to refer to any polyisocyanate compound having isocyanate groups directly attached to an aliphatic chain or ring. As used herein, the term, “aromatic polyisocyanates”, is intended to refer to any polyisocyanate compound having isocyanate groups directly attached to an aromatic ring.

As examples of suitable polyisocyanate compounds, hexamethylene diisocyanate, dodecamethylene diisocyanate, cyclohexene-1,4-diisocyanate, 4,4′-dicyclohexene methane diisocyanate, cyclopentene-1,3-diisocyanate, p-phenylene diisocyanate, toluene-2,4-diisocyanate, naphthalene-1,4-diisocyanate, diphenyl-4,4′-diisocyanate, benzene-1,2,4-triisocyanate, xylylene-1,4-diisocyanate, xylylene-1,3-diisocyanate, diphenylene methane diisocyanate, butane-1,2,3-triisocyanate, or polymethylene polyphenyl isocyanate can be used.

As examples of suitable isocyanate prepolymer, polyurethane based prepolymer of any of the multi-isocyanate compounds as given above, polyester based prepolymer of any of the multi-isocyanate compounds as given above, and polyether based prepolymer of any of the multi-isocyanate compounds as given above can be given. The polyurethane based prepolymer, the polyester based prepolymer or the polyether based prepolymer may be prepare by any suitable method well known to a person skilled in the art. For example, the polyurethane based prepolymer may be prepared by reacting a monomeric polyol with one or more of the polyisocyanate compounds under suitable conditions; the polyester based prepolymer or the polyether based prepolymer may be prepared by reacting polyester polyol or polyether polyol with one or more of the polyisocyanate compounds under suitable conditions. Alternatively, as the polyurethane based prepolymer, the polyester based prepolymer or the polyether based prepolymer, any suitable commercial available product can be used.

In one embodiment of the present application, the polyisocyanate comprises a water-dispersible polyisocyanate.

In another embodiment of the present application, the polyisocyanate includes an oil-soluble polyisocyanate and a co-solvent. In the present application, the co-solvent is a solvent that helps the oil-soluble polyisocyanate to disperse in the coating system, which is usually a water-soluble organic solvent, including but not limited to alcohols (such as methanol, ethanol, etc.), polyols (such as ethylene glycol, glycerol, etc.), alcohol ethers, ketones, or any combination thereof.

As an example of a polyisocyanate, any suitable commercially available product, those polymer having a chemical structure based on HDI or IPDI (hydrophilic aliphatic polyisocyanate based on hexamethylene diisocyanate (HDI)) or hydrophilic aliphatic polyisocyanate based on isophorone diisocyanate (IPDI)) can be given.

According to the present application, the amount ratio of polyisocyanate to Component A is in the range of 0.02 to 0.10:1, preferably in the range of 0.04 to 0.07:1. Generally speaking, when the amount ratio of polyisocyanate to Component A is less than 0.02:1, the radiation-curable hydroxyl-functional polymer in component A cannot cure well with the aid of less polyisocyanate and the radiation curing reaction of the present application cannot be further replenished beneficially. When the amount ratio of polyisocyanate to Component A is greater than 0.10:1, the radiation-curable hydroxy-functional polymer in component A will cure quickly with polyisocyanate, which will adversely affect the pot life of the radiation-curable two-component aqueous coating composition of the present application. According to actual needs, additional inert diluents that do not affect the reaction of the above Component A with polyisocyanate can be added during the preparation of Component A and/or polyisocyanate, for example, to reduce the viscosity of each component. Therefore, the amount of the Component A and polyisocyanate is not limited to the above range, and can be adjusted according to actual needs.

In one embodiment according to the present application, the radiation-curable two-component aqueous coating composition is an aqueous colorless varnish. As mentioned above, the aqueous clear varnishes can be formulated using conventional photoinitiators known in the art. The photoinitiators include, but are not limited to, acylphosphine oxides, alpha-hydroxy ketones, alpha-amino ketones, benzophenones, or combinations thereof.

In another embodiment according to the present application, the radiation-curable two-component aqueous coating composition is an aqueous solid color topcoat. As mentioned above, the aqueous solid color topcoat is preferably formulated using acylphosphine oxides as photoinitiators. Since solid color topcoats are generally opaque, the radiant energy absorbed by the coating composition beneath the surface layer may not be sufficient and deep curing of the coating may not be achieved. It was surprisingly found that deep curing of the coating can be achieved by using acylphosphine oxides as photoinitiators when the radiation-curable two-component aqueous coating composition is an aqueous solid color topcoat.

According to the present application, the radiation curable two-component aqueous coating composition may be prepared by simply mixing the Component A with the polyisocyanate curing agent in a mixing device at a predetermined weight ratio, prior to application. The mixed two-component coating composition can be applied in a variety of ways that are familiar to those skilled in the art, including spraying (e.g., air assisted, airless or electrostatic spraying), brushing, rolling, flooding and dipping. In an embodiment of the present application, the mixed two-component aqueous coating composition is coated by spraying. The two-component aqueous coating composition can be applied in various wet film thickness. In an embodiment of the present application, the wet film thickness is preferred to provide a dry film thickness in the range of about 13 to about 100 μm, preferably in the range of about 50 to 100 μm. The applied coating may be cured by accelerating drying in various drying devices e.g., ovens that are familiar to those skilled in the art.

In one embodiment of the present application, after mixing the components of the radiation-curable two-component aqueous coating composition, the resulting mixture has a pot life of 4-24 hours using ISO 9514:2019.

In another embodiment of the present application, when the radiation-curable two-component aqueous coating composition is cured on a white substrate to form a coating, the coating has a color difference value before and after irradiation upon subjecting to a QUV aging test using ASTM G154 for 360 hours of ΔE<2.0, preferably <1.4, more preferably <1.35.

In a second aspect according to the present application, the present application also provides a coated article comprising a substrate comprising at least one major surface; and a coating applied on part or all of the main surface of the substrate that is formed from the radiation-curable two-component aqueous coating composition according to the first aspect of the present application.

In some embodiments of the present article, the substrate can be any suitable substrate, including, but are not limited to wood, metal, plastic, feature, textile, ceramic or any combination thereof. Those skilled in the art will select and determine a suitable material as the substrate according to actual needs.

The substrate may be a non-heat-sensitive substrate, such as glass, ceramic, fiber, cement board, or metal for example aluminum, copper or steel, or a heat-sensitive substrate. Considering that the radiation-curable two-component aqueous coating composition of the present application can be cured with a radiation source that does not generate excessive additional heat, it is particularly suitable for providing coatings to heat-sensitive substrates, preferably wood.

Suitable heat-sensitive substrate comprises wood substrates, for example solid wood, such as for example: hard wood, soft wood, plywood; veneer, particle board, low density fibre board, medium density fibreboard and high density fibreboard, OSB (Oriented Strand Board), wood laminates, chipboard and other substrate in which wood is an important constituent, such as for example foil covered wooden substrates, engineered wood, plastic modified wood, plastic substrates or wood plastic compounds (WPC); substrates with cellulosic fibres, for example cardboard or paper substrates.

### Examples

The following examples describe the present application in more detail, which are for illustrative purposes only, since various modifications and changes will be apparent to those skilled in the art from the scope of the present application. Unless otherwise indicated, all parts, percentages, and ratios reported in the following examples are on a weight basis and all reagents used in the examples are commercially available and may be used without further treatment.

### Testing Methods

Unless otherwise indicated, the following test methods were used in the following examples.

### Pot Life

After mixing components of the radiation-curable two-component aqueous coating composition according to the present application, the time required for its viscosity to become twice the original viscosity was determined using ISO 9514:2019.

### Adhesion

An adhesion test was performed to assess whether the coating was adhered to the coated substrate. The adhesion test was performed according to ASTM D 3359—Test Method B. Adhesion is usually classified as 0-5B, where 5B represents the optimal adhesion.

### Gloss

This test was used to measure the gloss of the cured coating. A Sheen gloss meter was used to assess gloss at 60° according to ASTM D523.

### Hand Feel

This test was used to measure the human contact comfort of a cured coating. It is generally based on how rough/silky the surface is felt by hand touching the coating.

### Yellowing Resistance

The radiation curable coating composition was bladed on the BYK white coating film test cardboard, with a coating amount of 100-120 g/m²; then cured under a UV (Ga+Hg) light source with a curing energy of 1000-1500 mJ/cm². The coating obtained as above was used as a standard, and it was measured using a colorimeter. Then, the coating obtained as above was aged in a QUV aging machine using ASTM G154 for 360 hours, and the obtained coating was taken as a sample, which was then measured using a colorimeter. Next, the following formula was used to determine the coating color difference value before and after aging:

ΔE=[(ΔL*)²+(Δa*)²+(Δb*)²]^{1/2}

in which,
ΔL=Lₛₐₘₚₗₑ−L_{standard} (lightness difference); Δa=aₛₐₘₚₗₑ−a_{standard} (red/green difference); and
Δb=bₛₐₘₚₗₑ−b_{standard} (yellow/blue difference).
ΔE represents the total color difference;
Large ΔL means white, and small ΔL means black;
Large Δa means reddish, small Δa means greenish;
Large Δb means yellowish, small ΔL means blueish.

### Chemical Resistance

Resistance tests were performed according to ASTM F2250-Test Method B with solvents, including acids, bases, coffee, and ethanol, to evaluate the degree of “curing” or cross-linking of the coating. Finally, the integrity of the coating was determined. Chemical resistance is usually divided into 0-5 grades, where 5=the coating is intact and free of stains, no delamination (best), 4=the coating stains are barely noticeable, 3=the stained coating can be clearly identified, 2=the coating is discolored and blistered, softened, and 0=the coating has large bubbles, and has a tendency to delaminate (worst).

### Hardness

The pendulum hardness of the coating was tested according to ASTM D-3363 using a pendulum hardness tester from BYK-Gardner GmbH, expressed in counts.

### Raw Materials

Resin: Aqueous dispersion of caprolactone-modified radiation-curable hydroxyl-functional polyurethane that is solvent free;

Acylphosphine photoinitiator;

Hydroxyketone photoinitiator;

Organic matting agent 1: polyacrylate (PMMA) ultrafine powder with a particle size of 2-4 microns;

Organic matting agent 2: PMMA ultrafine powder with a particle size of 5-7 microns;

Organic matting agent 3: PMMA ultrafine powder with a particle size of 7-9 microns;

Silica matting agent

Wax-treated silica matting agent

Polymer treated silica matting agent

Polyisocyanate: Hydrophilic HDI curing agent

### Aqueous Coating Composition

As shown in Table 1, the ingredients of component A in the indicated amounts were mixed to form component A of the aqueous coating composition according to Example 1 of the present application, wherein Example 1 was a UV-curable two-component aqueous coating composition comprising polymethacrylics organic matting agent, Comparative Example (hereinafter abbreviated as CExample) 1 a was UV-curable two-component aqueous coating composition containing a silica matting agent, Comparative Example 2 was a UV-curable two-component aqueous coating composition containing a wax-treated silica matting agent, Comparative Example 3 was a UV-curable two-component aqueous coating composition comprising a polymer-treated silica matting agent; Comparative Example 4 was a UV-curable two-component aqueous coating composition containing PMMA organic matting powder with a particle size between 2-4 μm; and Comparative Example 5 was a UV-curable two-component aqueous coating composition containing PMMA organic matting powder with a particle size between 7-9 μm.

TABLE 1
Composition and Amount of Aqueous Coating Composition

| Raw | Example | Example | Example | CExample | CExample | CExample | CExample | CExample |
|---|---|---|---|---|---|---|---|---|
| material/g | 1 | 2 | 3 | 1 | 2 | 3 | 4 | 5 |
| Component A | | | | | | | | |
| resin | 80 | 80 | 80 | 80 | 80 | 80 | 80 | 80 |
| Acylphosphine | 1 | 1 | — | 1 | 1 | 1 | 1 | 1 |
| Photoinitiator | | | | | | | | |
| Hydroxyketone | 1 | — | 1 | 1 | 1 | 1 | 1 | 1 |
| Photoinitiator | | | | | | | | |
| water | 2.4 | 3.4 | 3.4 | 4.4 | 4.4 | 4.4 | 2.4 | 2.4 |
| PMMA | | | | | | | 3.5 | — |
| Matting agent | | | | | | | | |
| 1 | | | | | | | | |
| PMMA | 3.5 | 3.5 | 3.5 | | | | — | — |
| Matting agent | | | | | | | | |
| 2 | | | | | | | | |
| PMMA | | | | | | | — | 3.5 |
| Matting agent | | | | | | | | |
| 3 | | | | | | | | |
| Silica Matting | — | — | — | 1.5 | — | — | — | — |
| Agent | | | | | | | | |
| Wax-treated | — | — | — | — | 1.5 | — | — | — |
| silica matting | | | | | | | | |
| agent | | | | | | | | |
| Polymer | — | — | — | — | — | 1.5 | — | — |
| treated silica | | | | | | | | |
| matting agent | | | | | | | | |
| Colorant | 8 | 8 | 8 | 8 | 8 | 8 | 8 | 8 |
| Coalescent | 2 | 2 | 2 | 2 | 2 | 2 | 2 | 2 |
| thickener | 1.05 | 1.05 | 1.05 | 1.05 | 1.05 | 1.05 | 1.05 | 1.05 |
| Surfactant | 0.5 | 0.5 | 0.5 | 0.5 | 0.5 | 0.5 | 0.5 | 0.5 |
| defoamer | 0.5 | 0.5 | 0.5 | 0.5 | 0.5 | 0.5 | 0.5 | 0.5 |
| fungicide | 0.05 | 0.05 | 0.05 | 0.05 | 0.05 | 0.05 | 0.05 | 0.05 |
| total | 100 | 100 | 100 | 100 | 100 | 100 | 100 | 100 |
| Component B | | | | | | | | |
| polyisocyanate | 5 | 5 | 5 | 5 | 5 | 5 | 5 | 5 |

### Coating Properties

Component A and Component B of Examples 1-3 and Comparative Examples 1-5 above were mixed, and the resulting mixture was sprayed onto the surface of support substrate at a wet coating thickness of 150 microns. The coating thus formed was UV cured. The UV lamp used emitted UV light with a wavelength of 280-410 nm and a power of 5.6 KW. The coating compositions were then tested for its pot life, clarity, hand feel, chemical resistance (including those to which wood paint surface was frequently exposed), gloss, adhesion, hardness and color difference according to the methods described in the preceding test section, and the results were summarized in the table 2 below.

TABLE 2
Properties of the coatings

| | | Example | Example | Example | CExample | CExample | CExample | CExample | CExample |
|---|---|---|---|---|---|---|---|---|---|
| | | 1 | 2 | 3 | 1 | 2 | 3 | 4 | 5 |
| Pot Life/h | | 6 | 6 | 6 | 6 | 6 | 6 | 6 | 6 |
| feel | | 5 | 5− | 5− | 4 | 4 | 4 | 5 | 3 |
| Gloss @60° | | 29-31 | 29-31 | 29-31 | 30-32 | 30-32 | 30-32 | 37-40 | 27-29 |
| hardness | | H | F | HB | F | F | F | H | H |
| adhesion | | 5B | 5B | 5B | 5B | 5B | 5B | 5B | 5B |
| Color difference | | 1.3 | 1.35 | 1.36 | — | — | — | — | — |
| Chemical | 48% | 5 | 4 | 4 | 2 | 2+ | 2+ | 4 | 4 |
| Resistance | alcohol | | | | | | | | |
| | coffee | 5 | 4 | 4 | 3 | 3 | 3 | 4 | 3 |
| | yellow | 5 | 4 | 4 | 2 | 2 | 3 | 3 | 4 |
| | mustard | | | | | | | | |
| | Water | 5 | 5 | 5 | 4+ | 5 | 5 | 5 | 5 |
| | resistant | | | | | | | | |
| | @ 24 | | | | | | | | |
| | hours | | | | | | | | |
| | 5% | 5 | 4 | 4 | 2 | 3 | 3 | 3+ | 4 |
| | aqueous | | | | | | | | |
| | sodium | | | | | | | | |
| | hydroxide | | | | | | | | |
| | solution | | | | | | | | |
| | @ 4 | | | | | | | | |
| | hours | | | | | | | | |
| | 5% | 5 | 4 | 4 | 3 | 3 | 3 | 3+ | 4 |
| | aqueous | | | | | | | | |
| | sodium | | | | | | | | |
| | bicarbonate | | | | | | | | |
| | solution | | | | | | | | |
| | @ 1 | | | | | | | | |
| | hour | | | | | | | | |
| | 5% | 5 | 4 | 4 | 3 | 3 | 3 | 4 | 3+ |
| | aqueous | | | | | | | | |
| | sulfuric | | | | | | | | |
| | acid | | | | | | | | |
| | solution | | | | | | | | |
| | @ 4 | | | | | | | | |
| | hours | | | | | | | | |

Note:
Hand feel test: 1→5 feels rough → feels fine and silky

As can be seen from the results in Table 2, by adding an organic matting agent with a specific particle size to a dual-curing system composed of a radiation-curable hydroxy-functional polymer, a polyisocyanate and a photoinitiator, the resulting coating has a lower gloss and show significantly improved chemical resistance. Furthermore, in the radiation-curable two-component aqueous coating composition according to the present application, the formulated aqueous coating composition based on a caprolactone-based hydroxyl-functional urethane (meth)acrylate, and bisacylphosphine oxide combined with hydroxyketone exhibits particularly excellent color stability after curing.

### Embodiments

Embodiment 1: A radiation-curable two-component aqueous coating composition comprising: 1) Component A, comprising at least one radiation-curable hydroxy-functional polymer, at least one photoinitiator and at least one organic matting agent; and 2) Component B, comprising at least one polyisocyanate; wherein the organic matting agent is an acrylics polymer in the form of a dry powder, and the dry powder has a particle size of in the range of 4-8 microns, as measured by laser diffraction particle size analyzer using ISO 13320 (2009) (the Malvern method); and wherein when the radiation curable two-component aqueous coating composition is cured to form a coating, the coating has a gloss of no higher than 50 at 60° using ASTM D523.

Embodiment 2: An embodiment of Embodiment 1, wherein the dry powder has a particle size of in the range of 5 to 7 microns.

Embodiment 3: An embodiment of any of Embodiments 1-2, wherein relative to the total weight of the component A, the organic matting agent is present in an amount of in the range of 2-8% by weight, preferably in the range of 3-7 wt %, more preferably in the range of 3-6 wt %.

Embodiment 4: An embodiment of any of Embodiments 1-3, wherein the radiation-curable hydroxy-functional polymer is a hydroxy-functional polymer with ethylenically unsaturated functional groups, including a hydroxy-functional epoxy (meth)acrylate, a hydroxy-functional polyurethane (meth)acrylate, a hydroxy-functional polyester (meth)acrylate, a hydroxy-functional polyether (meth)acrylate, a hydroxy-functional polyacrylates (meth)acrylate or a combination thereof, preferably a hydroxyl functional polyurethane (meth)acrylate.

Embodiment 5: An embodiment of Embodiment 4, wherein the radiation-curable hydroxy-functional polymer comprises a modified hydroxy-functional polyurethane (meth)acrylate, preferably a caprolactone-based hydroxyl functional polyurethane (meth)acrylate.

Embodiment 6: An embodiment of any of Embodiments 1-5, wherein the radiation-curable hydroxy-functional polymer is in the form of an aqueous dispersion.

Embodiment 7: An embodiment of any of Embodiments 1-6, wherein the photoinitiator comprises acyl phosphine oxides, α-hydroxy ketones, α-amino ketones, benzophenones or a combination thereof, preferably a combination of acylphosphine oxides and α-hydroxy ketones.

Embodiment 8: An embodiment of any of Embodiments 1-7, wherein the radiation-curable hydroxy-functional polymer comprises a caprolactone-based hydroxy-functional polyurethane (meth)acrylate, and the photoinitiator comprises a combination of acylphosphine oxides and α-hydroxy ketones.

Embodiment 9: An embodiment of any of Embodiments 1-8, wherein the component A comprises, relative to the total weight of the component A, 65 to 90% by weight of the radiation-curable hydroxyl functional polymer; 2 to 8% by weight of the organic matting agent; 1 to 3% by weight of the photoinitiator; and 0 to 30% by weight of additional additives, including, colorants, water, coalescents, thickeners, surfactants, defoamers, bactericides, or any combination thereof.

Embodiment 10: An embodiment of any of Embodiments 1-9, wherein the polyisocyanate comprises a water-dispersible polyisocyanate.

Embodiment 11: An embodiment of any of Embodiments 1-9, wherein the polyisocyanate comprises an oil-soluble polyisocyanate and a co-solvent.

Embodiment 12: An embodiment of any of Embodiments 1-11, which is an aqueous colorless varnish.

Embodiment 13: An embodiment of any of Embodiments 1-11, which is an aqueous solid color topcoat.

Embodiment 14: An embodiment of any of Embodiments 1-13, wherein after mixing the components of the coating composition, the resulting mixture has a pot life of 4-24 hours using ISO 9514:2019.

Embodiment 15: An embodiment of any of Embodiments 1-14, wherein when the coating composition is cured on a white substrate to form a coating, the coating has a color difference value before and after irradiation upon subjecting to a QUV aging test using ASTM G154 for 360 hours of ΔE<2.0, preferably <1.4, more preferably <1.35.

Embodiment 16: A coated product comprising: a substrate, comprising at least one major surface; and a coating applied on part or all of the main surface of the substrate that is formed from the radiation-curable two-component aqueous coating composition according to any one of Embodiments 1-15.

Embodiment 6: An embodiment of Embodiment 16, wherein the substrate comprises one or more of wood, glass, ceramic, metal, plastic, and cement board.

While the present application has been described with reference to a number of embodiments and examples, those skilled in the art will readily recognize that changes may be made to the present application without departing from the principles disclosed in the foregoing specification. For example, without departing from the principles disclosed in the foregoing specification, the technical solutions obtained by combining multiple features or preferred modes described herein should be understood as belonging to the contents described herein. Such changes are considered to be included in the following claims unless the claims expressly state otherwise. Accordingly, the embodiments detailed herein are exemplary only and are not intended to limit the scope of the present application, which is the full scope of the appended claims and any and all equivalents thereof.

1. A radiation-curable two-component aqueous coating composition comprising:
Component A, comprising at least one radiation-curable hydroxy-functional polymer, at least one photoinitiator and at least one organic matting agent; and
Component B, comprising at least one polyisocyanate;
wherein the organic matting agent is an acrylics polymer in the form of a dry powder, and the dry powder has a particle size of in the range of 4-8 microns, as measured by laser diffraction particle size analyzer using ISO 13320 (2009) (the Malvern method); and
wherein when the radiation curable two-component aqueous coating composition is cured to form a coating, the coating has a gloss of no higher than 50 at 60° using ASTM D523.

2. The radiation curable two-component aqueous coating composition according to claim 1, wherein the dry powder has a particle size of in the range of 5 to 7 microns.

3. The radiation-curable two-component aqueous coating composition according to claim 1, wherein relative to the total weight of the component A, the organic matting agent is present in an amount of in the range of 2-8% by weight, preferably in the range of 3-7 wt %, more preferably in the range of 3-6 wt %.

4. The radiation-curable two-component aqueous coating composition according to claim 1, wherein the radiation-curable hydroxy-functional polymer is a hydroxy-functional polymer with ethylenically unsaturated functional groups, including a hydroxy-functional epoxy (meth)acrylate, a hydroxy-functional polyurethane (meth)acrylate, a hydroxy-functional polyester (meth)acrylate, a hydroxy-functional polyether (meth)acrylate, a hydroxy-functional polyacrylates (meth)acrylate or a combination thereof, preferably a hydroxyl functional polyurethane (meth)acrylate.

5. The radiation-curable two-component aqueous coating composition according to claim 4, wherein the radiation-curable hydroxy-functional polymer comprises a modified hydroxy-functional polyurethane (meth)acrylate, preferably a caprolactone-based hydroxyl functional polyurethane (meth)acrylate.

6. The radiation-curable two-component aqueous coating composition of claim 1, wherein the radiation-curable hydroxy-functional polymer is in the form of an aqueous dispersion.

7. The radiation curable two-component aqueous coating composition according to claim 1, wherein the photoinitiator comprises acyl phosphine oxides, α-hydroxy ketones, α-amino ketones, benzophenones or a combination thereof, preferably a combination of acylphosphine oxides and α-hydroxy ketones.

8. The radiation-curable two-component aqueous coating composition of claim 1, wherein the radiation-curable hydroxy-functional polymer comprises a caprolactone-based hydroxy-functional polyurethane (meth)acrylate, and the photoinitiator comprises a combination of acylphosphine oxides and α-hydroxy ketones.

9. The radiation curable two-component aqueous coating composition according to claim 1, wherein the component A comprises, relative to the total weight of the component A,
65 to 90% by weight of the radiation-curable hydroxyl functional polymer;
2 to 8% by weight of the organic matting agent;
1 to 3% by weight of the photoinitiator; and
0 to 30% by weight of additional additives, including, colorants, water, coalescents, thickeners, surfactants, defoamers, bactericides, or any combination thereof.

10. The radiation-curable two-component aqueous coating composition according to claim 1, wherein the polyisocyanate comprises a water-dispersible polyisocyanate.

11. The radiation-curable two-component aqueous coating composition according to claim 1, wherein the polyisocyanate comprises an oil-soluble polyisocyanate and a co-solvent.

12. The radiation curable two-component aqueous coating composition according to claim 1, which is an aqueous colorless varnish.

13. The radiation curable two-component aqueous coating composition according to claim 1, which is an aqueous solid color topcoat.

14. The radiation-curable two-component aqueous coating composition according to claim 1, wherein after mixing the components of the coating composition, the resulting mixture has a pot life of 4-24 hours using ISO 9514:2019.

15. The radiation-curable two-component aqueous coating composition according to claim 1, wherein when the coating composition is cured on a white substrate to form a coating, the coating has a color difference value before and after irradiation upon subjecting to a QUV aging test using ASTM G154 for 360 hours of ΔE<2.0, preferably <1.4, more preferably <1.35.

16. A coated product comprising
a substrate, comprising at least one major surface; and
a coating applied on part or all of the main surface of the substrate that is formed from the radiation-curable two-component aqueous coating composition according to claim 1.

17. The coated article of claim 16, wherein the substrate comprises one or more of wood, glass, ceramic, metal, plastic, and cement board.
